(19) United States
(12) Patent Application Publication
(10) Pub. No.: US 2021/0380294 A9
(43) Pub. Date: Dec. 9, 2021

(54) Method and Apparatus for Gripping and Holding Dispensing Elements, Having a Flange and a Screw Cap, for Subsequent Application onto Packages

(71) Applicant: SIG Technology AG, Neuhausen am Rheinfall (CH)

(72) Inventors: Joachim Bührer, Stuehlingen (DE); Martin Rüegg, Uhwiesen (CH); Daniel Weber, Schaffhausen (CH)

(21) Appl. No.: 16/629,884

(22) PCT Filed: Jun. 26, 2018
(86) PCT No.: PCT/EP2018/025176

§ 371 Date: Jan. 9, 2020

(30) Foreign Application Priority Data
Jul. 10, 2017 (DE) 10 2017 115 337.3

(51) Int. Cl. B65B 43/50; B65B 61/18; B65B 7/28

(52) U.S. Cl. CPC B65B 43/50; B29C 66/53247; B65B 7/2807; B65B 61/186

(57) ABSTRACT

A method and apparatus are represented and described for gripping and holding dispensing elements, having a flange and a screw cap, for subsequent application onto packages, wherein the dispensing elements are linearly supplied to the apparatus in an aligned position and wherein each dispensing element is gripped individually by gripper jaws of a gripping device and is applied by means of its flange onto a package. In order that an applicator with smaller structural height can, even in the case of higher speeds, also reliably provide packages comprising an oblique gable with a dispensing elements, the following steps are provided: raising each gripping device into a start position above the supplied dispensing elements, lowering each gripping device with opened gripper jaws from their highest position to a dispensing element provided therebelow, wherein the transport speed of the gripping device and the transport belt are synchronised, pulling a dispensing element with opened gripper jaws to a flat delivery region, gripping a dispensing element by closing the gripper jaws, lowering each gripping device with gripped dispensing element to a package transported therebelow in an application position, pressing the dispensing element onto the package for a predefined time, and releasing the applied dispensing element and raising each gripping device to receive a newly-supplied dispensing element.

The invention relates to a method and an apparatus for gripping and holding dispensing elements, having a flange and a screw cap, for subsequent application onto packages, in particular cardboard/plastic composite packages for dispensable products, with the dispensing elements being linearly supplied to the apparatus in an aligned position and with each dispensing element being gripped individually by gripper jaws of a gripping device and being applied by means of its flange onto a package.

When “dispensing elements” are mentioned in the present case, this should not be understood as pure dispensing elements, but rather also resealable opening elements of all types, which are nowadays mainly used at the same time as dispensing elements. For the sake of brevity however, only dispensing elements are mentioned in this application.

Cardboard/plastic composite packages are known from practice in widely different variations. The composite material comprises at least one carrier layer made of cardboard and in each case layers of polyethylene sealed on the outside which protects the cardboard from moisture. The composite material can also contain an aluminium layer for aseptic filling products in order to achieve a good barrier effect against gases and also light. The actual forming and filling of the packaging and the subsequent sealing to form a package occurs in a packaging machine which is generally also referred to as an FFS machine (form-fill-seal machine). The known packages are manufactured either from individual package sleeve blanks (so-called blanks) or filled with product from a package laminate of the roll and sealed and separated only after the manufacturing of the package.

The filled and sealed packages are often provided in a subsequent step with package aids such as for example resealable opening and dispensing elements. This occurs by means of separate applicators, to which the finished packages have to be supplied individually. The application takes places in this case normally on a predetermined weakened area on the package gable, such as for example a so-called “an overcoated hole” which is matched to the dispensing element to be applied in each case.

A method and an apparatus for applying dispensing elements onto packages with all the features of the preamble of claim 1 or claim 8 are known from the generic EP 1 813 533 A1. In this case, dispensing elements supplied linearly are firstly delivered to individual stations of an applicator. The applicator delivers, in the case of the known apparatus by means of a plurality of gripping devices, the dispensing elements to the surface sections of the packages intended for this purpose which are also supplied to the apparatus on a linear transport path. To this end, means for the coordinated movement of the gripping devices are present in order to move them to apply the dispensing elements onto the packages in a vertical plane. The packages are removed after the application of the dispensing elements.

What is disadvantageous with the previously described apparatus is that the dispensing elements supplied upside down by means of the gripping devices of the applicator must change their position in the spatial environment about a horizontal axis in a vertical plane. To this end, a significant structural height of the applicator is required.

Proceeding from here, the object underlying the present invention is to design and further develop the method mentioned in the introduction and a corresponding apparatus for gripping and holding dispensing elements, having a flange and a screw cap, for subsequent application onto packages such that an applicator with lower structural height can, even in the case of higher speeds, also reliably provide packages comprising an oblique gable with dispensing elements, in the case of which the surface sections provided for the application with a dispensing element run in a plane inclined to the horizontal plane.

This object is achieved in the case of a method with the features of the preamble of claim 1 by the following steps:
Raising each gripping device into a start position above the supplied dispensing elements,
Lowering each gripping device with opened gripper jaws from their highest position to a dispensing element provided therebelow by a transport belt, with the transport speed of the gripping device and the transport belt being synchronised,
Pulling a dispensing element with opened gripper jaws to a flat delivery region,
Gripping a dispensing element by closing the gripper jaws,
Lowering each gripping device with gripped dispensing element to a package transported therebelow in an application position,
Pressing the dispensing element onto the package for a predefined time and
Releasing the applied dispensing element and raising each gripping device to receive a newly-supplied dispensing element.

According to the invention, a very exact and therefore operationally-secure delivery of the individually supplied dispensing elements to the gripping device is achieved which operates essentially free of interruptions even at high machine speeds.

In the case of an apparatus with the features of the preamble of claim 8, the object is achieved in that the gripping devices are arranged in a height-adjustable manner on an applicator designed as a rotary machine, in that each gripping device is arranged above a package transported by the applicator, in that each gripping device has at least two corresponding gripper jaws to grip a dispensing element, in that the dispensing elements are supplied by means of a transport belt and lateral guide rails to a delivery region to be received by the gripping devices and in that the transport belt has a plurality of engagement cams to receive the dispensing elements and in that the distance between two supplied dispensing elements corresponds to the distance between two gripping devices. The construction according to the invention is particularly expedient in regards to the relatively low space requirement of the applicator.

According to the invention, the dispensing elements are supplied by means of a transport belt and lateral guide rails to a delivery region to be received by the gripping devices. By using a transport belt, it is possible to accelerate the supplied dispensing elements very precisely to the speed of the gripping devices.

Furthermore, the transport belt has according to the invention a plurality of engagement cams to receive the dispensing elements and the distance between two supplied dispensing elements corresponds to the distance between two gripping devices. Since the distance between two gripping devices is predefined by the construction of the applicator, the length of the transport belt can also be freely selected accordingly, with an integral multiple of the distance always determining the entire length of the belt.

Rotary machines are understood as all applicators, in the case of which the transport paths of the dispensing elements to be applied and transported on the applicator are transported along a path which is largely identical to the transport path of the packages transported by the applicator. Ideally, rotary tables are also understood by this, with the term rotary machines, however, also expressly comprising such applicators in the case of which the transport paths of the dispensing elements and packages deviate from a round shape.

A further teaching according to the invention is characterised in that the supplied dispensing elements are accelerated by means of the transport belt to the speed of the gripping devices. In this way, there is always synchronisation between rotational speed of the applicator and belt speed. For the actual delivery of the supplied dispensing elements, it is provided according to a further configuration of the invention that in the case of lowering each gripping device the opened gripper jaws engage the dispensing element provided therebelow in a positive-locking manner in the region of a screw cap. Expediently, the dispensing element is preferably released following the positive-locking engagement of the opened gripper jaws from its forced guidance and transported further only by the opened gripper jaws. If a dispensing element is located on the flat delivery region, it will be released by the gripper jaws from its forced guidance and gripped in the region between the screw cap lower edge and the flange in a positive-locking and force-fitting manner and transported further by the gripping device.

A further teaching of the invention provides that the flange of each dispensing element is wetted with an adhesive after gripping by an application station to wet the flange of the dispensing element.

Alternatively, it is, however, also provided that the flange of each dispensing element is activated by means of heat, UV light or the like after gripping by an activation station to activate the contact region of the flange of the dispensing element.

According to a further teaching of the invention, each gripping device is arranged on the applicator pivotable about a horizontal axis. In this way, it is possible to always pivot the gripping device in a vertical plane in the correct alignment to the package located directly therebelow.

A preferred configuration of the invention provides that the gripping devices are arranged uniformly distributed over the circumference of the applicator. In this way, the highest possible number of gripping devices can be accommodated on the outer circumference of the applicator.

A further preferred teaching of the invention provides that the gripping devices move on a circular path and that the lateral guide rails are designed such that they divert the dispensing elements initially to the applicator before the delivery region until they are guided on the circular path by means of the correspondingly running lateral guide rails to the delivery region where firstly the lateral guide rails and subsequently also the transport belt end. In this way, it means that the time, in which each dispensing element and the gripping device lowering above on the dispensing element are positioned exactly over one another, is increased. This is in particular notably important in the case of higher machine speeds.

For the actual delivery of the dispensing elements to the gripping devices, it is provided in a further configuration of the invention that the still open gripping jaws of the lowering gripping devices engage the dispensing elements in the region of the bent lateral guide rails of the circular path and pull them, through contact of the open gripper jaws with the screw cap of the dispensing elements, into the delivery region where the closing gripper jaws grip the respective dispensing elements in the region between the screw cap lower edge and the flange in a positive-locking and force-fitting manner. To this end, it is particularly expedient when the delivery region is formed by a sliding surface on which the dispensing elements slide along the circular path until being received by the gripper jaws. The length of the sliding surface must in this case only be configured so large that the gripper jaws fixedly hold the screw cap enclosed.

In a further preferred configuration of the invention, it is provided that an application station for adhesive on the flange is arranged in the transport direction along the circular path behind the sliding surface forming the delivery region. This can be designed for example as a glue roller such that the dispensing elements there can also be uniformly wetted with adhesive with the flange underside pointing downwards. Instead of an application station, an activation station can alternatively be provided for activating joining agent already present on the flange or even the flange material itself. This can for example occur by means of heat, UV light or the like.

According to a further teaching according to the invention, the gripper jaws of each gripping device can be moved towards one another. To this end, each gripping device preferably has two gripper jaws in order to keep the constructive complexity and also the structural size of the gripping device low.

Alternatively to the linearly movable solution, however, it is also possible that the gripper jaws of the gripping device are pivotable towards one another in a further configuration of the invention.

Different technical solutions are conceivable as the drive for opening and closing the gripper jaws. The gripper jaws are particularly preferably pneumatically actuated to open and close. However, it is also possible that the drive for opening and closing the gripper jaws takes place hydraulically or electromechanically.

The invention is explained in greater detail below by means of a drawing merely depicting a preferred exemplary embodiment. In the drawing,

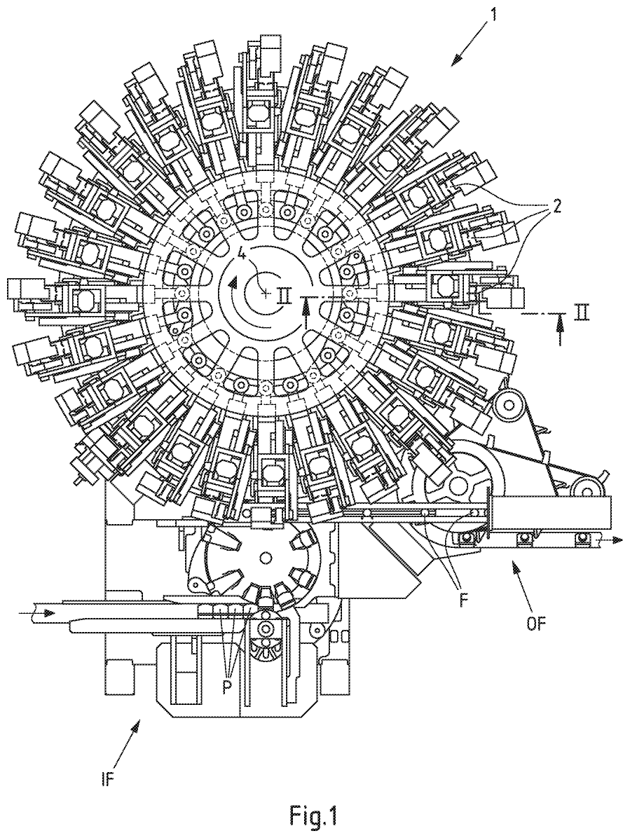

FIG. 1 shows an apparatus according to the invention in plan view,

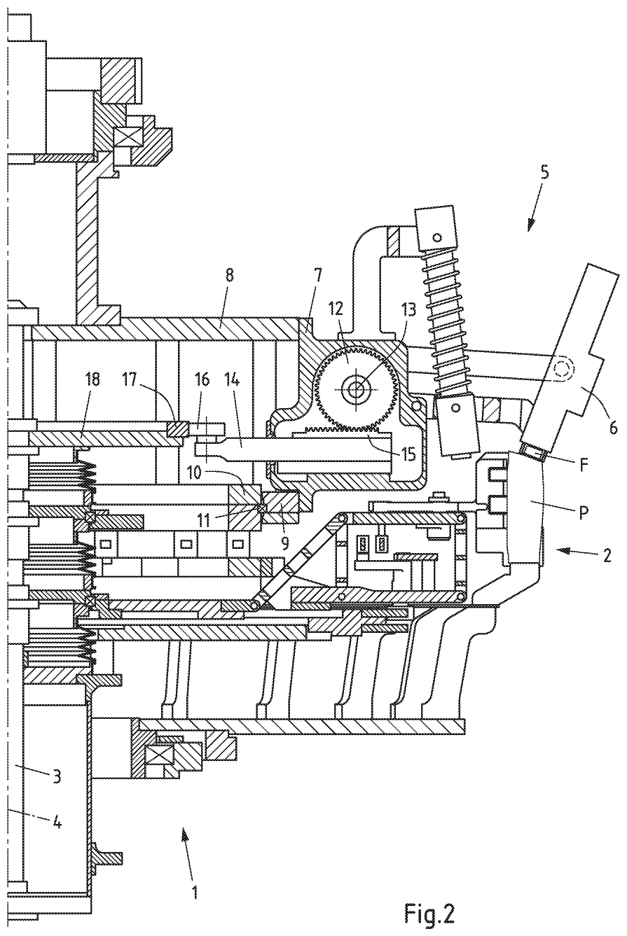

FIG. 2 shows the apparatus according to the invention from FIG. 1 in vertical section along the line II-II in FIG. 1,

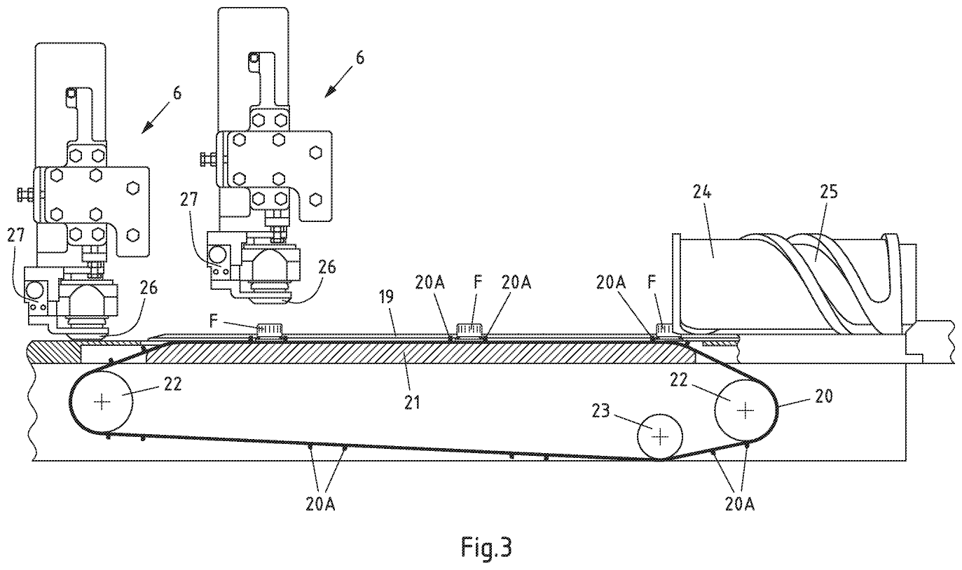

FIG. 3 shows a part of the apparatus according to the invention with a supply rail and a transport belt for dispensing elements and two gripping devices,

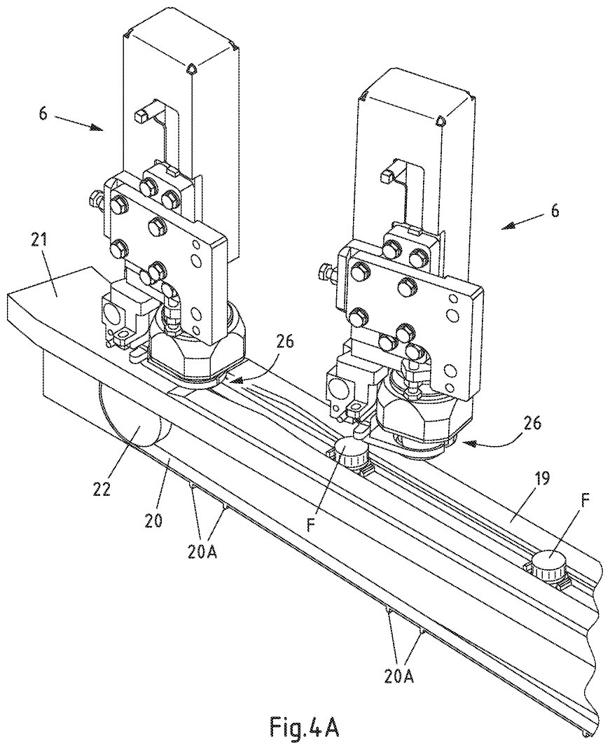

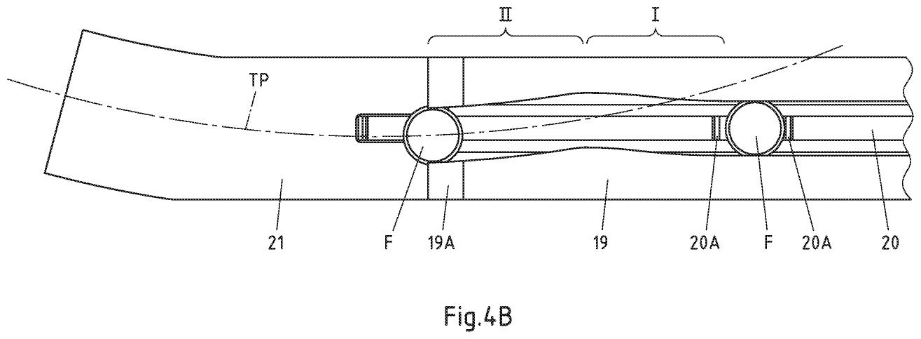

FIG. 4A shows the gripping devices and the supply rail from FIG. 3 in perspective representation,

FIG. 4B shows the supply rail from FIG. 3 in plan view,

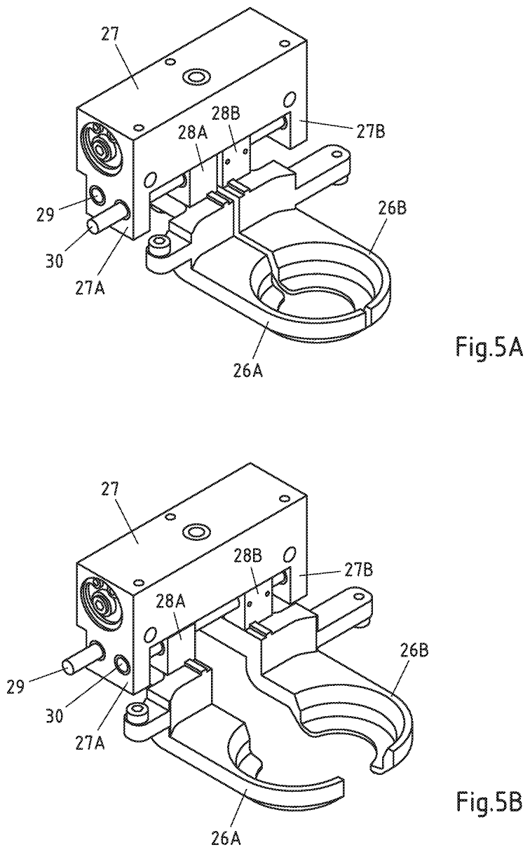

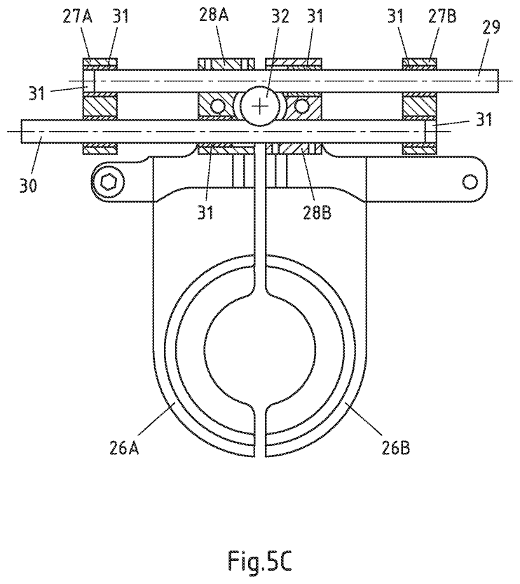

FIG. 5A and 5B show a gripper of the gripping devices from FIG. 3 in different positions in perspective representation,

FIG. 5C shows the gripper from Fig. SA in plan view and

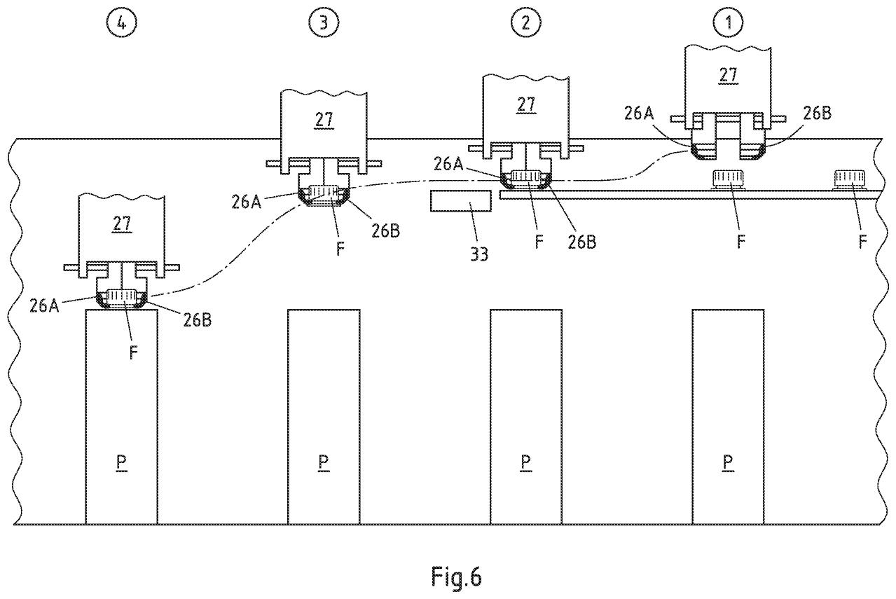

FIG. 6 shows a schematic representation of the movement path of the gripping devices in the case of the receiving and application operation of the dispensing elements.

The apparatus according to the invention is represented in plan view in FIG. 1. It substantially consists of an applicator 1 and a supply device IF with which packages P filled and sealed upright and supplied in the direction of the left arrow in the drawing are separated and supplied to the individual positions in transport units 2 of the applicator 1. Dispensing elements F are also delivered to the applicator 1 in order to be applied by said applicator onto the packages P. After the dispensing elements F have been applied onto the packages P, the packages P are again removed from the transport units 2 of the applicator 1 in an ejection device OF and supplied for their further use. To this end, they leave the apparatus according to the invention in the direction of the arrow on the right edge of the ejection device OF. The rotary direction runs, predefined by the arrangement of supply device IF and ejection device OF of the packages P, in the exemplary embodiment in the clockwise direction, represented by a middle arrow in FIG. 1.

FIG. 2 shows the apparatus according to the invention from FIG. 1 in the vertical section along the line II-II in FIG. 1. For improved representation, only half of the applicator 1 is represented. It can be discerned that the applicator 1 is driven by a vertical drive shaft 3 about a rotary axis 4. The drive of the applicator 1 can, however, also be carried out indirectly.

The applicator 1 designed as a rotary machine has, in the exemplary embodiment represented in FIG. 1 and preferred in this respect, twenty-four transport units 2 and correspondingly also twenty-four application units 5 which are arranged over the transport units 2. Each application unit 5 has a gripping device 6 in order to receive in each case one dispensing element F to be applied. The dispensing elements F are applied by the gripping elements 6 after corresponding application of a joining agent on the gable surfaces of the packages P inclined outwards in relation to the applicator 1 and pressed on there until drying or hardening.

FIG. 2 shows the application unit 5 in its application position in which the gripping device 6 presses the received dispensing element F on the gable surface of the package P clamped in the transport unit 2. According to the invention, the gripping device 6 is arranged on the application unit 5 by means of a four bar linkage about which further detail will be given later.

In the represented exemplary embodiment, each application unit 5 has a housing 7 which is fastened at the top on a carrier disc 8 arranged in the upper region of the applicator 1, with the carrier disc 8 being connected in a torque-proof manner to the drive shaft 3 of the applicator 1 in the represented and in this respect preferred exemplary embodiment. The housing 7 is supported below on a rotating bezel 9 which is arranged coaxially about a support ring 10 of the applicator 1. The support ring 10 is connected to an adjustment device to adjust the transport units 2. As will be explained in more detail further below, both the rotating bezel 9 and the support ring 10 are designed in two parts and thus enclose a common bearing 11. In this way, the position of the gripping device 6 can be modified in the circumferential direction in relation to the position of the transport unit 2 located therebelow within predefined limits in order to align the dispensing element F to be applied optimally on its application location on the package gable.

In the interior of the housing 7, a gear wheel 12 can be discerned which is rotatable about a horizontally running rotary axis 13. The teeth located in the lower region of the gear wheel 12 engage into the teeth of a rack 15 fixedly arranged on a control rod 14. The free end of the control rod 14 has a rotatably arranged control roll 16 which rolls on a control curve 17. The control curve 17 is fastened on a stationary carrier disc 18 of the applicator 1. In order that the control roll 16 always rolls in fixed contact on the control curve 17, the application unit 5 is designed spring-loaded by a spring not designated in further detail which acts via the gear wheel 12 indirectly on the control rod 14.

FIG. 3 shows a vertical section in the region of the separation device of the apparatus according to the invention designed as a screw conveyor 24. It can be discerned that the cylindrical structure of the screw conveyor 24 has a screw thread forming an engagement groove 25 such that in each case one dispensing element F is transported in the engagement groove 25 and are delivered at the correct point on a cam belt 20 laterally delimited by guide rails 19, which has at a corresponding distance in each case one pair of cams 20A protruding outwardly perpendicular to the transport direction, in which cams the dispensing element F is transported to the delivery region where it is delivered to the gripping device 6 of the applicator A. The cam belt 20 is led in the region its contact with the dispensing elements F via a slide rail 21 and is led around deflection rollers 22 and a tension roller 23. Each gripping device 6 has at its lower end in the represented and in this respect preferred exemplary embodiment two gripper jaws 26 and a drive housing 27 which are described below in greater detail.

The delivery of the dispensing elements F to the gripping devices 6 can be particularly clearly discerned from FIG. 4A. Since the gripping devices 6 are arranged outside of the applicator 1 (not represented) designed as a rotary machine, they move on a circular path, while the dispensing elements F linearly approximate the delivery region, as previously mentioned for FIG. 3. In order to achieve a particularly reliable delivery here, it is discernible from FIG. 4 that the lateral guides 19 deflect, shortly before their end, the guide path towards the applicator (not represented) until the dispensing elements F have arrived exactly on the circular path of the gripping devices 6 and are then led by the guide rails 19 to their end precisely along this circular path. To this end, the spacing distance between two engagement cams 20A is somewhat greater than the flange of the dispensing element F such that said dispensing element can move freely perpendicular to the transport direction of the cam belt 20 in the region of the deflected guide rail 19.

To explain better, the end region of the guide rails 19 and the adjoining delivery region is represented in FIG. 4B as a plan view without the gripping devices. The already described circular path TP of the gripping devices 6 is firstly drawn in there in relation to the middle point of the gripper jaws in a dashed manner with the reference numeral TP. It is also discernible that the straight guide rails 19 have in a first section I before the delivery region a deflection of the dispensing element in the direction of the applicator (not represented) and therefore of the circular path TP until the middle point of the dispensing element is located exactly on the circular path TP. From there, through a corresponding configuration of the guide rails 19, the further transport of the dispensing elements F begins exactly on the circular path TP, as represented in section II. At their end, the guide rails 19 are grasped in the region 19A and pass to the sliding surface 21 of the delivery region. At the same time, as already known from FIG. 3, the transport belt 20 descends downwards such that, behind the section II, the transport of the dispensing element F takes place exclusively by way of the gripping device 6 lowered over the dispensing element. The sliding surface 21 is designed such that there is sufficient time available to close the gripper jaws (not represented) of the gripping device.

The core piece of each gripping device is represented in greater detail in FIG. 5A to 5C. FIG. 5A and 5B show the gripper jaws 26A and 26B in their closed and open position. The gripper jaws 26A and 26B are movable linearly towards one another in the exemplary embodiment represented and preferred in this respect. To this end, each gripping device firstly has a housing 27 in which the mounting of the gripper jaws 26A and 26B is housed. To this end, the housing 27 has, at its ends, two limbs 27A and 27B reaching downwards and a bearing block 28A is provided on the housing-side end of the gripper jaws 26A and a corresponding bearing block 28B is provided on the gripper jaw 26B. The bearing block 28A is in this case fixedly connected to a guide axis 29 and the bearing block 28B to a guide axis 30. The guide axis 29 is firstly guided in corresponding bearings 31 into the two limbs 27A and 27B of the housing 27, as can in particular be inferred from FIG. 5C. Since the guide axis 29 also extends through the bearing block 28B and the guide axis 30 through the bearing block 28A, these bearing blocks are also provided with corresponding bearings 31.

In order that the middle point of the gripper jaws 26A and 26B are now always located exactly at the correct point (which is optimised for subsequent application) of the circular path TP, a pinion 32 is provided between the two guide axes 29 and 30. Furthermore, the guide axes 29 and 30 are preferably provided at least on the side facing one another in each case with a rack such that the teeth of the pinion 32 can interlock with the teeth of the racks (not represented) and in this way synchronisation of the opening and closing movement of the gripper is achieved.

Lastly, FIG. 6 shows in a schematic representation the movement of the gripping device 6 in the case of the application operation. In its uppermost position, position \textcircled{1}, in which the gripper jaws 26A and 26B are open, it is lowered to receive a dispensing element F provided below the gripping device and initially encompasses the screw cap of the dispensing element F in order to ensure its transport in the delivery region after the forced guidance carried out. In this case, the gripper jaws 26A and 26B close and the dispensing element F is gripped in the groove between screw cap and flange in a positive-locking and force-fitting manner, as represented in position \textcircled{2}. Thereafter, it initially remains at the height of the delivery region and, in the case of further transport, wets the underside of the fastening flange of the dispensing element F with an adhesive in an application station 33, which is only indicated. Such application stations are known separately for example from DE 100 17 609 A1 going back to the applicant.

Thereafter, the vertical pivoting of the gripping device 6 begins in the direction of the package P located below the gripping device 6. Here, a somewhat deeper position \textcircled{3} is firstly shown in an intermediate position. The gripping device 6 is now pivoted further downwards into its lowermost position in which the dispensing element F is applied on the gable surface of the package P, represented as position \textcircled{4}. The gripping device 6 remains in this application position in the applicator 1 and presses the dispensing element F against the gable of the package until the adhesive dries. Then, it releases the dispensing element F and moves back into its uppermost position, position \textcircled{1} in order to receive a further dispensing element F following a rotation of the applicator 1. This operation is repeated in the case of constant rotational movement of the applicator 1 for each attached gripping device 6 during the application operation.

For a better overview, an oblique position of gripping device 6 and dispensing element F and the package gable of the packages P have been dispensed with in the schematic representation in FIG. 6 Furthermore, the gripper jaws 26A and 26B are represented pivoted about a vertical axis 90° for simplicity in order to be able to show the initially open and subsequently closed position of the gripper jaws 26A and 26B.

1. A method for gripping and holding dispensing elements, having a flange and a screw cap, for subsequent application onto packages, in particular cardboard/plastic composite packages for dispensable products, wherein the dispensing elements are linearly supplied to the apparatus in an aligned position and wherein each dispensing element is gripped individually by gripper jaws of a gripping device and is applied by means of its flange onto a package
characterised by the following steps:
raising each gripping device into a start position above the supplied dispensing elements,
lowering each gripping device with opened gripper jaws from their highest position to a dispensing element provided therebelow, wherein the transport speed of the gripping device and the transport belt are synchronised,
pulling a dispensing element with opened gripper jaws to a flat delivery region,
gripping a dispensing element by closing the gripper jaws,
lowering each gripping device with gripped dispensing element to a package transported therebelow in an application position,
pressing the dispensing element onto the package for a predefined time and
releasing the applied dispensing element and raising each gripping device to receive a newly-supplied dispensing element.

2. The method according to claim 1,
characterised in that
the supplied dispensing elements are accelerated by means of the transport belt to the speed of the gripping devices.

3. The method according to claim 1,
characterised in that
when lowering each gripping device these engage the dispensing element provided therebelow, in the case of opened gripper jaws, in a positive-locking manner in the region of its screw cap.

4. The method according to claim 1,
characterised in that
the dispensing element released following the positive-locking engagement from its forced guidance by lateral guide rails and pulled further only by the gripping device.

5. The method according to claim 4,
characterised in that
in the delivery region the gripper jaws grip the dispensing element released from its forced guidance in the region between the screw cap lower edge and the flange in a positive-locking and force-fitting manner and transport them further.

6. The method according to claim 1,
characterised in that
the flange of each dispensing element is wetted with an adhesive after gripping by an application station to wet the flange of the dispensing element.

7. The method according to claim 1,
characterised in that
the flange of each dispensing element is activated by means of heat, UV light or the like after gripping by an activation station to activate the contact region of the flange of the dispensing element.

8. An apparatus for gripping and holding dispensing elements, having a flange and a screw cap, for subsequent application onto packages, in particular cardboard/plastic composite packages for dispensable products, wherein the dispensing elements are linearly supplied to the apparatus in an aligned position and wherein each dispensing element is gripped individually by a gripping device and is applied by means of its flange onto a package,
characterised in that
the gripping devices are arranged in a height-adjustable manner on an applicator designed as a rotary machine, in that each gripping device is arranged above a package transported by the applicator, in that each gripping device has at least two corresponding gripper jaws to grip a dispensing element, in that the dispensing elements are supplied by means of a transport belt and lateral guide rails to a delivery region to be received by the gripping devices and in that the transport belt has a plurality of engagement cams to receive the dispensing elements and in that the distance between two supplied dispensing elements corresponds to the distance between two gripping devices.

9. The apparatus according to claim 8,
characterised in that
each gripping device is arranged on the applicator pivotable about a horizontal axis.

10. The apparatus according to claim 8,
characterised in that
the gripping devices are arranged uniformly distributed over the circumference of the applicator.

11. The apparatus according to claim 8,
characterised in that
the gripping devices move on a circular path and in that the lateral guide rails are designed such that they divert the dispensing elements initially towards the applicator before the delivery region until they are guided on the circular path by means of the correspondingly running lateral guide rails to the delivery region where firstly the lateral guide rails and subsequently also the transport belt end.

12. The apparatus according to claim 11,
characterised in that
the lowering gripping devices engage the dispensing elements in the region of the bent lateral guide rails of the circular path and pull them with the screw cap of the dispensing elements into the delivery region where the closing gripper jaws grip the respective dispensing elements in the region between the screw cap lower edge and the flange in a positive-locking and force-fitting manner.

13. The apparatus according to claim 8,
characterised in that
the delivery region is formed by a sliding surface on which the dispensing elements slide along the circular path until being received by the gripper jaws.

14. The apparatus according to claim 13,
characterised in that
an application station for applying adhesive on the flange is arranged in the transport direction along the circular path behind the sliding surface forming the delivery region.

15. The apparatus according to claim 13,
characterised in that
an activation station to activate the contact region of the flange of the dispensing element by means of heat. UV light or the like is arranged in the transport direction along the circular path behind the sliding surface forming the delivery region.

16. The apparatus according to claim 8,
characterised in that
the gripper jaws of each gripping device can be moved towards one another.

17. The apparatus according to claim 16,
characterised in that
the gripper jaws of each gripping device can be pivoted towards one another.

18. The apparatus according to claim 8,
characterised in that
the drive for opening and closing the gripper jaws takes place pneumatically.

19. The apparatus according to claim 8,
characterised in that
the drive for opening and closing the gripper jaws takes place hydraulically.

20. The apparatus according to claim 8,
characterised in that
the drive for opening and closing the gripper jaws takes place electromechanically.
